(19) United States
(12) Patent Application Publication
(10) Pub. No.: US 2016/0283913 A1
(43) Pub. Date: Sep. 29, 2016

(54) DEVICE, PROCESS, AND COMPUTER PROGRAM FOR CREATING A CHRONOLOGICAL SEQUENCE OF ACTIVITIES OF A USER

(71) Applicant: VOLKSWAGEN AG, Wolfsburg (DE)

(72) Inventor: Wolfgang THEIMER, Bochum (DE)

(73) Assignee: VOLKSWAGEN AG

(21) Appl. No.: 15/080,625

(22) Filed: Mar. 25, 2016

(30) Foreign Application Priority Data
Mar. 26, 2015 (DE) 10 2015 205 482.9

(51) Int. Cl. G06Q 10/10; G06F 17/30

(52) U.S. Cl. CPC G06Q 10/1095; G06F 17/3053

(57) ABSTRACT

A device for creating a temporal sequence of activities of a user. The device includes a storage module designed to store at least information on a planned activity of the user. The information relating to the activity has at least one time period available to the user to carry out the activity. The device also includes an assignment module designed to determine at least one combination of a possible beginning and a possible time duration of the activity within the time period available to the user, and assigns a weighting coefficient to the at least one combination. The device also includes a calculation module designed to make a selection from the at least one combination of a possible beginning and a possible time duration of the activity.

### PRIORITY CLAIM

This patent application claims priority to German Patent Application No. 10 2015 205 482.9, filed 26 Mar. 2015, the disclosure of which is incorporated herein by reference in its entirety.

### SUMMARY

Illustrative embodiments relate to the field of devices and methods for creating a temporal sequence of activities of a user.

### BACKGROUND

Mobility services which support a user in the planning for his personal mobility serve multiple purposes in everyday use. Different mobility services may take into account, for example, a selection of routes, weather conditions, traffic information or costs in the planning. However, information of this type may change rapidly in time. It may happen as a result that the requirements of the user are only partially and not adequately met. Increased traffic volume or a strong networking of road users may possibly even exacerbate these problems. Although information that could have an influence on the mobility of the user can be made available, for example, by external providers via the Internet, in many cases this information is not taken into account. Furthermore, it may be problematic in the case of some mobility services to respond to a change in conditions within a specified time frame or to provide the user with mobility information in a timely manner. Moreover, further inputs by the user may frequently be required for a reliable planning by means of a conventional mobility service, which may impede usage.

Illustrative embodiments simplify a user mobility planning concept for the user.

### BRIEF DESCRIPTION OF THE DRAWINGS

A number of disclosed embodiments are described and explained in detail below with reference to the attached figures. The details shown are as follows:

FIG. 1 shows a block diagram of a device for creating a temporal sequence of activities of a user according to at least one disclosed embodiment;

FIG. 2 shows a graphical representation of a weighting coefficient depending on a beginning of an activity according to at least one disclosed embodiment;

FIG. 3 shows a graphical representation of a time duration of an activity depending on a beginning of an activity according to at least one disclosed embodiment;

FIG. 4 shows a graphical representation of correlations between a time duration of an activity and a weighting coefficient according to disclosed embodiments;

FIG. 5 shows a block diagram of an architecture of a program to carry out a method for creating a temporal sequence of activities of a user according to at least one disclosed embodiment;

FIG. 6 shows a block diagram for an interaction of a user with a program to carry out a method for creating a temporal sequence of activities of a user according to at least one disclosed embodiment; and

FIG. 7 shows a flow diagram of a method for creating a temporal sequence of activities of a user according to another disclosed embodiment.

### DETAILED DESCRIPTION OF THE DISCLOSED EMBODIMENTS

Disclosed embodiments relate to a device for creating a temporal sequence of activities of a user. The device comprises a storage module which is designed to store at least information relating to a planned activity of the user. The information relating to the activity comprises at least one time period available to the user to carry out the activity. The device furthermore comprises an assignment module which is designed to determine at least one combination of a possible beginning and a possible time duration of the activity within the time period available to the user, and to assign a weighting coefficient to the at least one combination. The device furthermore comprises a calculation module which is designed to make a selection from the at least one combination of a possible beginning and a possible time duration of the activity. The selection is made in such a way that a weighting term comprising the weighting coefficient assigned to the selected combination does not exceed a predefined limit value, and the selection of a beginning and a time duration of the activity does not overlap with an additional time duration of an additional activity stored in the storage module. This may simplify a planning of activities or a timetable with these activities to the extent that time periods provided for other activities are taken into account or, if necessary, readjusted. The timetable may possibly therefore also be designed more efficiently in terms of a total quantity of planned activities. Further inputs of the user may possibly no longer be required.

In some disclosed embodiments, the assignment module is designed to specify the possible time duration depending on the possible beginning of the activity, and/or vice versa. A flexible, temporally variable planning can thus be enabled which can also take into account temporary conditions, such as, for example, peak traffic times or weather-related influences.

In some disclosed embodiments, the storage module is designed to store the information relating to the activity. Here, the information comprises predefined location information for the location of the activity. It may thus be possible to link the temporal sequence of activities with a navigation to a destination or to base it on a navigation of this type.

In some disclosed embodiments, the assignment module is designed to specify the time duration on the basis of the location information. This makes it possible to improve a route planning in terms of a time requirement, or to compare different routes or means of transport with one another.

In some disclosed embodiments, the assignment module is designed to assign the weighting coefficient to the at least one combination on the basis of a distance between a position corresponding to the location information and a starting position of the user. A time requirement for a route to be traveled can thus also be taken into account.

In some disclosed embodiments, the assignment module is designed to assign the weighting coefficient to the at least one combination. The starting position corresponds to additional location information assigned to the additional activity. A transition from an activity to the additional next activity is hereby enabled, wherein possible detours may no longer be required.

In some disclosed embodiments, the calculation module is designed to transmit a request signal, on the basis of the location information, to a further storage module which instigates a provision of a coordinate indication corresponding to the location information. This may in some cases allow a broader selection of input options of a location by a user.

In some disclosed embodiments, the calculation module is designed to compare the combination of a possible beginning and a possible time duration of the activity with a further combination of a further possible beginning and a further possible time duration of the activity within the time period. The calculation module is furthermore designed to determine a local or overall minimum of the weighting term on the basis of the comparison. The calculation module is furthermore designed to provide the user with the possible beginning and the possible time duration of the activity and/or an additional possible beginning and the additional possible time duration of the additional activity which correspond to the minimum of the weighting term within a predefined tolerance range. This can enable a reduction or even optimization of a time or cost requirement for at least the activity.

In some disclosed embodiments, the storage module is designed to store the information relating to the activity. Here, the information comprises a preferred time interval for the possible beginning and the possible time duration of the activity within the time period. As a result, restrictions can be specified by the user with increased precision.

In some disclosed embodiments, the assignment module is designed to determine the weighting coefficient on the basis of a position in time of the possible beginning of the activity in relation to the preferred time interval. This may possibly allow temporal fluctuations within the interval to be taken into account or an increased weighting to be given to times outside the interval that are unfavorable from a user perspective.

In some disclosed embodiments, the assignment module is designed to assign the time duration or the possible beginning of the activity to the weighting coefficient via a non-linear relationship. This can make it possible, for example, to ignore an insignificant time requirement below the specified limit in the weighting.

In some disclosed embodiments, the assignment module is designed to set the weighting coefficient to a specified value above the predefined limit value if the possible beginning of the activity lies outside the preferred time interval. As a result, a planning of an activity outside a user-defined time interval can be impeded or even prevented.

In some disclosed embodiments, the assignment module is designed to assign an additional weighting coefficient to the additional activity. The calculation module is designed to calculate a weighting term as the sum of the weighting coefficient and the additional weighting coefficient. A mathematical rule can be defined herewith for a precise comparison of a plurality of planning options, which may, where appropriate, improve planning efficiency.

Disclosed embodiments also relate to a method for creating a temporal sequence of activities of a user. The method comprises a storage of at least information relating to a planned activity of the user. The information relating to the activity comprises at least one time period available to the user to carry out the activity. The method furthermore comprises a determination of at least one combination of a possible beginning and a possible time duration of the activity within the time period available to the user. The method furthermore comprises an assignment of a weighting coefficient to the at least one combination. The method furthermore comprises a making of a selection from the at least one combination of a possible beginning and a possible time duration of the activity in such a way that a weighting term comprising the weighting coefficient assigned to the selected combination does not exceed a predefined limit value, and the selection from a beginning and a time duration of the activity does not overlap with an additional time duration of an additional activity stored in the storage module. A planning of activities can thus be produced in which conflicts can possibly be avoided. Furthermore, a temporal flexibility in the planning may be improved in some cases, or a planning facility can be created which allows an adaptation of the planning in line with temporally variable constraints.

In addition, further disclosed embodiments also provide a program or computer program with a program code to carry out one of the aforementioned methods when the program code is executed on a computer, a processor or a programmable hardware component, such as e.g. an application-specific integrated circuit (ASIC).

Different disclosed embodiments will now be described in more detail with reference to the attached drawings, in which a number of disclosed embodiments are shown. The thickness dimensions of lines, layers and/or regions may be shown in exaggerated form for the sake of clarity.

In the description of the attached figures which show disclosed embodiments, the same reference numbers denote the same or comparable components. Summarizing reference numbers are furthermore used for components and objects which occur multiple times in at least one disclosed embodiment or in a drawing but are described jointly in terms of one or more features. Components or objects which are described with the same or summarizing reference numbers may be designed identically in terms of individual, a plurality of or all features, for example, their dimensioning, but in some instances may also be designed differently, unless otherwise explicitly or implicitly indicated in the description.

Although disclosed embodiments may be modified and adapted in different ways, disclosed embodiments in the figures are presented as examples and are described in detail herein. However, it should be made clear that there is no intention to limit disclosed embodiments to the respectively disclosed forms, but rather that disclosed embodiments are intended to cover all functional and/or structural modifications, equivalents and alternatives that fall within the scope of the disclosed embodiments. The same reference numbers denote the same or similar elements in the entire description of the figures.

It should be noted that an element that is designated as “connected” or “coupled” to another element may be directly connected or coupled to the other element or that intermediate elements may be present. On the other hand, if an element is designated as “directly connected” or “directly coupled” to another element, no intermediate elements are present. Other terms that are used to describe the relationship between elements should be interpreted in a similar manner (e.g. “between” as opposed to “directly between”, “adjacent” as opposed to “directly adjacent”, etc.).

The terminology used herein serves only to describe specific disclosed embodiments and is not intended to limit the disclosed embodiments. As used herein, the singular forms “a”, “an” and “the” are also intended to include the plural forms, unless the context clearly indicates otherwise. It should furthermore be made clear that expressions such as “contains”, “containing”, “has” and/or “having”, “comprises” and/or “comprising”, as used herein, indicate the existence of specified features, integers, steps, workflows, elements and/or components, but do not exclude the presence or the addition of one or more features, integers, steps, workflows, elements, components and/or groups thereof.

Unless otherwise defined, all terms used herein (including technical and scientific terms) have the same meaning that an average person skilled in the art in the field to which the disclosed embodiments belong attributes to them. It should furthermore be made clear that expressions, e.g. those that are defined in generally used dictionaries are to be interpreted as if they had the meaning that is consistent with their meaning in the context of the relevant technology, and are not to be interpreted in an idealized or excessively formal sense, unless this is expressly defined herein.

A personal mobility planning may increase in complexity over time. This may be due to increasing traffic, rising costs for mobility or an increase in the networking of road users which in some cases may generate conflicting requirements that change rapidly in time for a personal mobility behavior. On the other hand, many information sources (e.g. route planners, weather, traffic and toll information, mobility services) exist on the Internet which could provide comprehensive data for a mobility planning. However, the user may be overburdened here in finding a solution, e.g. for a journey, which is adequately acceptable to him and which takes a minimum amount of relevant information into account. This may be the case, for example, when constraints change, or the user does not have sufficient time for a journey preparation.

Disclosed embodiments aim to introduce a personal mobility agent as a service which accommodates the requirements of the user (e.g. journey destinations and journey time period or constraints such as a cost or time minimization), autonomously analyses traffic-related databases and websites and relieves the user of the organization of released time intervals in respect of the mobility destinations. The user can be given a planning proposal for a reserved time period and, where appropriate, simply accept the proposal.

Many conventional route planners (on-board and off-board solutions) exist which can perform a route planning under given constraints (e.g. time or journey length). However, these solutions can only come into play when the user defines and enters his journey requirements, i.e. they cannot operate autonomously. Furthermore, more extensive mobility solutions exist, such as e.g., Moovel, which can produce a multimode journey planning with different means of transport, and can also estimate the associated costs. However, it may also be necessary here for the user to perform his input operations individually for each route. Google Now can, for example, make suitable recommendations to the user for his current activity profile which may also relate, inter alia, to the route planning. However, these conventional solutions may be based on very specific inputs of the user (e.g. destination or time period) or may make recommendations that can be determined from a large user cross section through computer-based learning methods. However, these approaches cannot be used in some situations, since the user, even if he knows his mobility wishes, does not have the time or leisure to communicate these to the technical system. It may similarly be desirable for a system only to make suggestions to the user that are verified (e.g. through short-term reservation of a proposed parking space). Conventional solutions exist which can automatically optimize partial aspects of the mobility, e.g. an automatic route planning if a driver does not follow a prescribed route.

Disclosed embodiments aim to address the aforementioned circumstances together in an integrated application, and possibly even carry out an automatic planning of action sequences based on a calendar, task lists or requests for joint meetings.

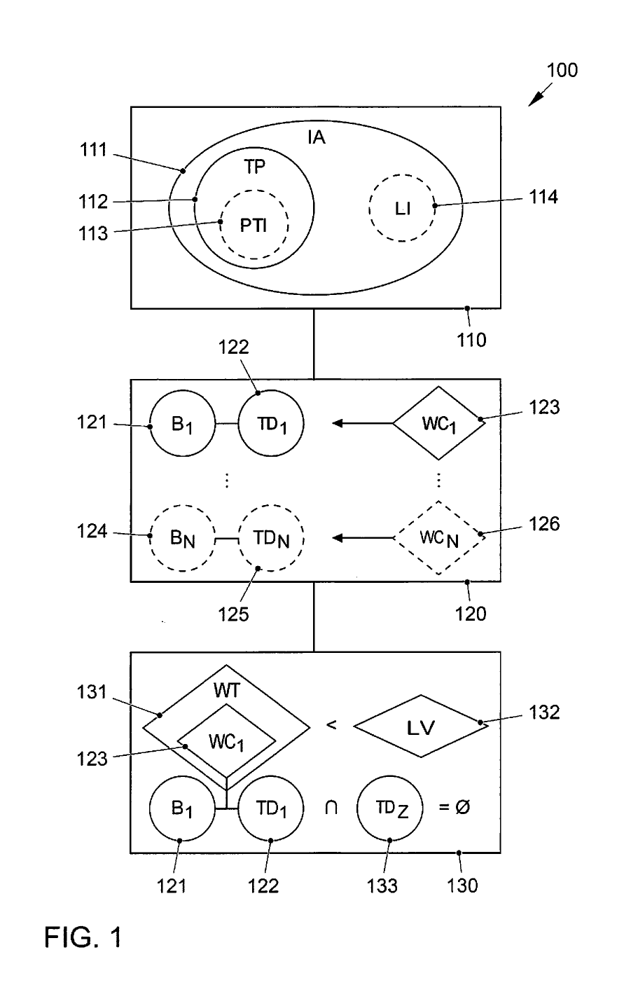

FIG. 1 shows a block diagram of a device 100 for creating a temporal sequence of activities of a user according to at least one disclosed embodiment. The device 100 comprises a storage module 110 which is designed to store at least information on a planned activity 111 of the user. The information relating to the activity 111 comprises at least one time period 112 available to the user to carry out the activity. The device furthermore comprises an assignment module 120 which is designed to determine at least one combination of a possible beginning 121 and a possible time duration 122 of the activity within the time period 112 available to the user, and to assign a weighting coefficient 123 to the at least one combination. The device furthermore comprises a calculation module 130 which is designed to make a selection from the at least one combination of a possible beginning 121 and a possible time duration 122 of the activity. The selection is made in such a way that a weighting term 131 comprising the weighting coefficient 123 assigned to the selected combination does not exceed a predefined limit value 132, and the selection from a beginning 121 and a time duration 122 of the activity does not overlap with an additional time duration 133 of an additional activity stored in the storage module 110. The detailed meaning of the abbreviations used in FIG. 1 is as follows: IA=Information relating to the activity, TP=time period, PTI=preferred time interval, LI=location information, Bn=possible beginning of the activity (nε{1, . . . , N}), TDn=possible time duration of the activity (nε{1, . . . N}), WCn=weighting coefficient (nε{1, . . . N}), WT=weighting term, LV=limit value, TDA=time duration of an additional activity. Optionally provided components are shown by means of dashed-line shapes.

In more precise terms, the assignment module 120 can determine a number of N combinations of a possible beginning 121 and a possible time duration 122 of the activity. Here, N may be any given natural number. Accordingly, one or more further combinations of a further possible beginning 124 and a further possible time duration 125 can optionally be determined and a further weighting coefficient 126 can be assigned to the combination(s). The time period 112 may comprise, for example, a specified quantity, initial quantity or total quantity of combinations in each case of a beginning and a time duration of the activity. The possible beginning 121 may correspond to a starting point of the possible time duration 122. The weighting coefficient 123 may correspond e.g. to an abstract cost concept which takes into account real financial costs and virtual costs corresponding to a time requirement. In other words, the weighting coefficient 123 may be a numerical value that is calculated on the basis of a sum of financial and temporal costs (if necessary with different predefined weighting factors). The weighting term 131 may correspond to an individual or a sum of a plurality of weighting coefficients 123. The weighting term 131 may apply to all activities planned within a specified time period (or, for example, to those activities of which the stored information 111 has a common time period 112). The weighting term 131 may furthermore be equal to the weighting coefficient 123 for only one stored activity. The time duration 122 of the activity may initially comprise the duration of an action defining the activity, e.g. work to be carried out, a meeting of the user with a further person, or a purchase. In further disclosed embodiments, the time duration 122 may also comprise an arrival and/or departure. Thus, in some disclosed embodiments, only the arrival and the action, but not the departure may be comprised, for example, if the user continues travelling from a location at which the activity takes place directly to an additional location at which the additional activity takes place.

The storage module 110, assignment module 120 and calculation module 130 may, for example, be spatially separated and may be interconnected via interfaces to exchange data or information. Alternatively, the storage module 110, assignment module 120, and calculation module 130 may also be integrated in a common component, or may be formed by the latter. In at least one disclosed embodiment, the common component is a processor, but may also be an application-specific integrated circuit (ASIC), a microcontroller, chip or otherwise programmable hardware component, or may comprise such a component. The functionalities described above which are performed by the storage module 110, assignment module 120 and calculation module 130 (or the common hardware component) are implemented in at least one disclosed embodiment as a program or software. This program is also referred to below as a mobility agent or intelligent mobility agent.

An activity list of at least one or more activities can be specified by the user. The intelligent mobility agent can be improved or even optimized by minimizing a cost function in which a number of tasks to be performed with costs (financial expenditure and allowed time intervals) are documented and a summation of all costs is carried out.

In other words, the calculation module 130 is designed in some disclosed embodiments to compare the combination of a possible beginning 121 and a possible time duration 122 of the activity with the further combination of the further possible beginning 124 and the further possible time duration 125 of the activity within the time period 112. The calculation module 130 is furthermore designed to determine a local or overall minimum of the weighting term 131 on the basis of the comparison. The calculation module 130 is furthermore designed to provide the user with the possible beginning 121 and the possible time duration 122 of the activity and/or an additional possible beginning and the additional possible time duration 133 of the additional activity which corresponds to the minimum of the weighting term 131 within a predefined tolerance range. The local or overall minimum of the weighting term 131 may also correspond to a user-preferred or optimum compromise between the time requirement and the cost requirement for the given activity list. A determination can also be carried out only after reducing the financial requirement or only after reducing the time requirement. “Within a predefined tolerance range” may mean, for example, that a cost and/or time requirement may be up to 10% above the minimum of the weighting term 131. The tolerance range may, for example, correspond to the predefined limit value 132, but may also deviate downwards from it. A predefinition of values or value ranges may, for example, be effected by the user and may have taken place before a creation of a time sequence of activities by means of the mobility agent.

In this disclosed embodiment, the possible beginning 121, the possible time duration 122, the further possible beginning 124 and the further possible time duration 125 are assigned in each case to the activity. The weighting coefficient 123 is incorporated as an alternative to the further weighting coefficient 126 into the weighting term 131. On the other hand, the additional possible beginning and the additional possible time duration 133 are assigned to the additional activity which differs from the activity. The additional possible beginning and the additional possible time duration 133 may form an additional combination which is assigned to an additional weighting coefficient. The additional weighting coefficient is additionally incorporated into the weighting term 131, for example, through summation with the weighting coefficient 123 or the further weighting coefficient 126. In other words, the assignment module 120 is designed in some disclosed embodiments to assign an additional weighting coefficient to the additional activity. The calculation module 130 is designed to calculate a weighting term 131 as the sum of the weighting coefficient 123 and the additional weighting coefficient. In other words, for example, a minimum of the weighting coefficient 123 or, in conjunction with all activities to be performed (e.g. on one day), a minimum of the weighting term 131 can be determined for each activity individually.

The user can store information relating to an individual activity or to a plurality of activities in the storage module 110. For example, A is assumed here to be an activity list with N mandatory tasks Ai and M optional tasks Oi. The quantity A thus comprises the elements {A1, . . . AN,O1, . . . OM}. The terms “mandatory” and “optional” may be user-defined. For example, a mandatory task (activity) may be scheduled by the device 100 within a limited time period, for example, the time period 112. An optional task (activity) may, if necessary, also be scheduled by the device 100 outside the time period, i.e. in a further time period which differs from the time period 112.

A series of activities can be freely interchanged (cf. also the “Traveling Salesman Problem”), so that all N! permutations for the mandatory activity list can be explored. However, user-defined restrictions (such as e.g. scheduled on-site visits) may apply, so that the number of alternatives to be explored may be restricted compared with the possible number N! of permutations. If the mandatory task list is completed under the given cost limit (which may correspond e.g. to the limit value 132), optional tasks can be added. A number of permutations may then be increased to (N+M)!.

The information relating to the activity 111 which can be stored e.g. in connection with a calendar entry by the user or automatically by heuristics in the storage module 110 may comprise a plurality of partial information elements. In some disclosed embodiments, partial information of this type is predefined location information 114 for a location of the activity. The location information 114 may be indicated as an address, as position coordinates or as addresses or localities predefined by the user (e.g. office, home, filling station, supermarket). “Predefined” means, for example, that the location information is uniquely assignable to a coordinate position. A user can thus store a unique address or coordinate position under the term “home” in the storage module 110 and, with a subsequent input of the term “home” by the user, this term could be assigned to the unique address without further user input. “Predefined” can also mean that the location information can be restricted at least to a plurality of uniquely assignable locations situated within a user-defined radius. For example, the location information “filling station” could be assigned to a number of five possible destinations within a 10 km radius, wherein each destination has a unique coordinate position which is known to the device 100 or can at least be determined by the device 100. In some further disclosed embodiments, the calculation module 130 is designed to transmit a request signal on the basis of the location information 114 to a further storage module which instigates a provision of a coordinate indication corresponding to the location information 114. In other words, the location can also be determined automatically by existing services if keywords are specified (e.g. theater, filling station, workshop, etc.). The further storage module may thus be comprised e.g. by a computer which is connected via the Internet to the storage module 110 (server) and on which a corresponding service is installed. The further storage module may also be comprised by a further device on which a further mobility agent runs and which is assigned to a further user.

In some disclosed embodiments, the time duration 122 is defined by the assignment module 120 on the basis of the location information 114. In other words, the time duration 122 may increase or decrease with a distance between a current or preceding position of the user and the location position corresponding to the location information 114 for a following activity. The assignment module 120 may furthermore be designed to assign the weighting coefficient 123 to the at least one combination of the possible beginning 121 of the activity and the possible time duration 122 of the activity on the basis of a distance between a position corresponding to the location information 114 and a starting position of the user. In other words, financial costs (e.g. for train or bus journeys or due to fuel consumption) or time-related costs (which may, where relevant, correspond to a temporal distance) may increase with increasing spatial distance, as a result of which the weighting coefficient 123 may increase accordingly.

As already described hereinabove, the possible time duration 122 may indicate a pure performance time of the activity. This may fluctuate depending on constraints, such as e.g. weather, traffic or time of day (which may, for example, correspond to the possible beginning 121 of the activity). The time duration 122 may be defined automatically by the system (e.g. journey duration of a navigation). It is also possible for the time duration 122 to be defined by the user as a specification of the user (e.g. duration of a meeting). In other words, the time duration 122 may already correspond to the user-defined time period 112 comprised by the information relating to the activity 111. This may be desirable, for example, if an activity with a predefined performance time is planned for a fixed time. For example, the user may store an appointment for a two-hour seminar for Wednesdays at 16:00 hrs in the storage module 110.

In another disclosed embodiment, the time period 112 may designate a total time period in which an activity can in principle take place. The time period 112 can thus be at least as long as the time duration 122 of the activity. The difference between the time period 112 and the time duration 122 of the activity may represent a buffer time which can be used by the device 100 in the planning to reduce costs.

Further possible partial information may comprise an activity type. Different types of activity may exist which may, where appropriate, be handled differently. An activity can be assigned to one, but also to a plurality, of types. A type may, for example, be a purchase which is characterized by a list of objects to be acquired. The information relating to an activity of the “purchase” type may optionally have a shopping list comprising objects to be bought. With this activity type, an associated shop can be stored automatically behind an object, or shops can be searched for which simultaneously cover as many objects as possible or match user-defined preferences.

Another type may be a journey, and may be defined in that the location of a previous activity does not correspond to the location of the activity with the “journey” type, i.e. may require transport. This activity type can be planned e.g. automatically by the device 100, and a corresponding user input may therefore in some instances no longer be required. In some disclosed embodiments, the starting position corresponds to additional location information assigned to the additional activity. In other words, an activity A1 can be carried out at a location X1 and the user can then be instructed to travel immediately from there to a location X2 to carry out an activity A2 there. A return journey to a starting position before the performance of the activity A1 (e.g. to home or to the office) can thus be avoided.

An activity of the “journey” type may allow a booking of tickets or overnight stays, reservation of parking spaces or other resources by the device 100. In other words, the mobility agent running on the device 100 can be designed, as a result of a default setting by the user, to carry out, for example, an online booking via the Internet through communication with a server.

Further activity types comprise professional work which is carried out personally without meetings with other persons, or private work which is carried out personally without meetings with other persons. A different activity type is a meeting, e.g. a professional or private meeting with other persons. An activity of the “meeting” type may possibly instigate or require an information exchange between the mobility agent of the user via the device 100 with a different mobility agent of a different user, which will be discussed in further detail below.

The weighting term 131 may represent a cost function for improving journeys and other tasks. Any given task or activity can be documented with abstract costs which comprise at least actual financial costs of the performance (e.g. for a journey) and virtual time-dependent costs. The abstract costs can be represented by the weighting coefficient 123. The time-dependent costs may be used to take into account e.g. a time requirement dependent on the time of day, or even to penalize the performance of the activity in “prohibited” times. “Prohibited” times may be derived from a user input and may relate to times at which a performance of an activity is not possible or is not appropriate or desired from a user perspective. In at least one disclosed embodiment of this type, the information 111 stored by the storage module 110 comprises a preferred time interval 113 for the possible beginning 121 and the possible time duration 122 of the activity within the time period 112. This preferred time interval 113 may, for example, be a hard criterion (firm appointment). In some disclosed embodiments, the information 111 furthermore comprises a preferred time for the beginning 121 of the activity. In the exploration of permutations of the activities from the activity list, this time may represent an anchor point or, in other words, the only possible beginning, e.g. the user can plan as an activity to take his child to school at 08:00 hrs. Furthermore, the assignment module 110 may be designed to set the weighting coefficient 123 to a specified value above the predefined limit value 132 if the possible beginning 121 of the activity lies outside the preferred time interval 113. In other words, if, for example, a task is to be carried out only in the preferred time interval 113, costs CO which are higher than the maximum acceptable costs Cmax can be set for all times outside this interval. The preferred time interval 113 can also be designated accordingly as the permitted time range.

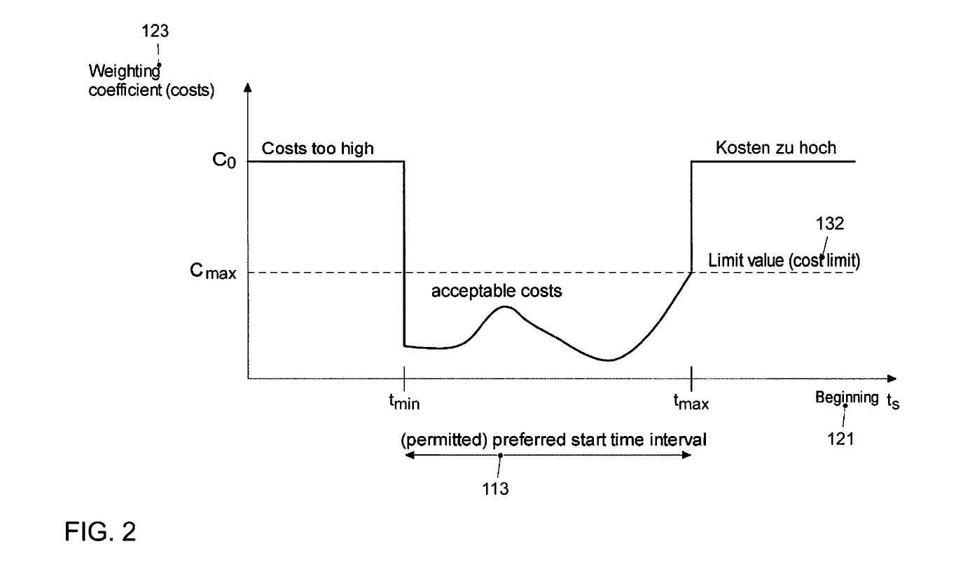

This is shown in graphical form in FIG. 2, which shows an example of a cost function for an activity with a restricted permitted time range. Here, t stands for the beginning 121 (start time) of the activity. An activity at the “prohibited” time outside the allowed time range 113 for this activity may, for example, comprise a journey to a post office at 03:00 hrs at night. The preferred time interval 113 is limited by an earliest start time tmin and a latest start time tmax. Outside the time interval, the costs (and therefore the weighting coefficient 123) have the value CO. In some disclosed embodiments, the assignment module 120 is, in other words, designed to determine the weighting coefficient 123 on the basis of a temporal position of the possible beginning 121 of the activity in relation to the preferred time interval 113. Within the preferred time interval 113, the costs may be below Cmax. Here, it may be possible that the costs are time-variant for a task, i.e. they depend on when a task is started. As shown in FIG. 2, the costs may fluctuate, for example, due to changeable traffic volume.

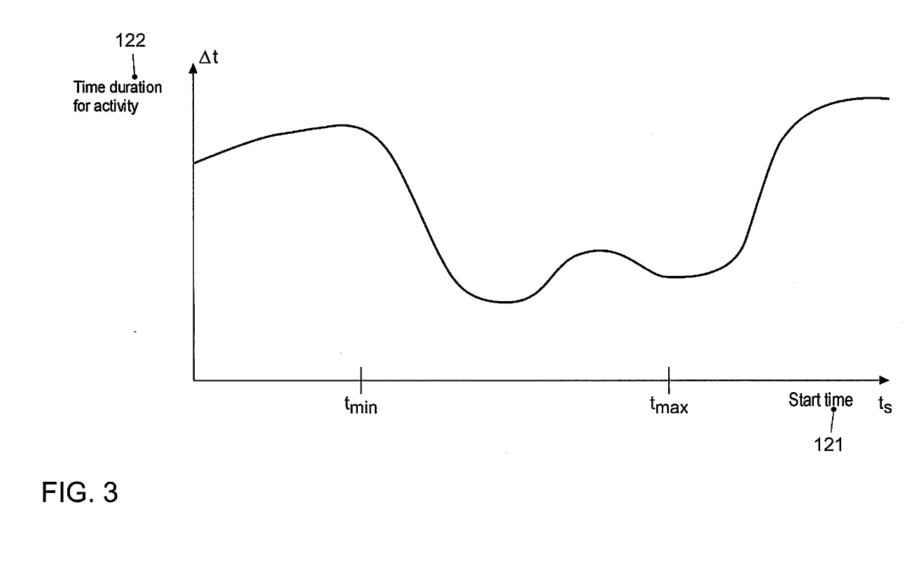

In some disclosed embodiments, the assignment module 110 is designed to specify the possible time duration 122 depending on the possible beginning 121 of the activity, and/or vice versa, as graphically illustrated in FIG. 3. The required time duration for the activity can thus represent a further influencing variable in the activity planning. In other words, the possible time duration 122 denoted Δt may be dependent on a time of day (e.g. due to traffic fluctuations during journeys) or on other variables such as weather conditions. The mobility agent can analyze given environmental conditions and produce estimates for the expected time duration of an activity depending on the beginning 121 (designated here as the start time ts).

A sequence of activities of the user may be scheduled, for example, by reducing or even minimizing costs. The activities previously stored by the user in the storage module 110 can be carried out sequentially. The mobility agent can explore all or a specified quantity of permissible permutations. At least one disclosed embodiment of a procedure which can result in a selection of an optimum activity sequence is described below.

In some disclosed embodiments, a weighting coefficient 123 is defined for each activity, i.e., a cost function S(ts), which records the financial costs C(ts) and the time duration Δt(ts) depending on the start time ts:

S(tₛ)=αfc(C(tₛ))+βf_{Δt}(Δt(tₛ))

The cost and time duration are weighted as a linear combination with the proportionality factors α and β. Costs can therefore also be assigned to the time duration, since an excessively high time requirement for an activity is, where relevant, to be avoided.

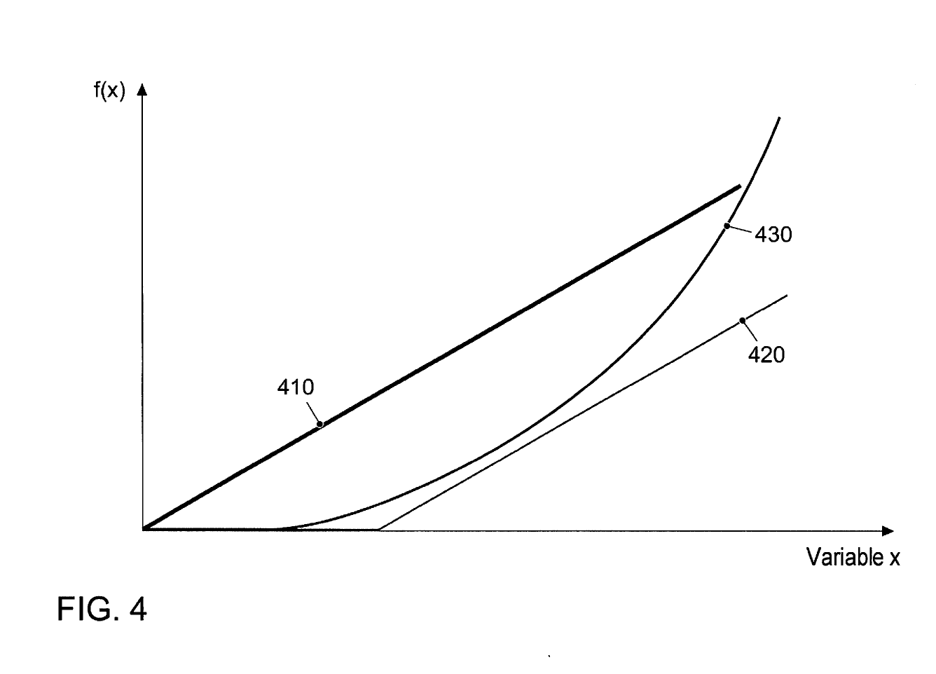

In some disclosed embodiments, the assignment module 120 is designed to assign the time duration 122 or the possible beginning 121 of the activity to the weighting coefficient 123 via a non-linear relationship. The costs and time duration can thus be incorporated linearly or non-linearly into the total costs S(ts), and can be evaluated with a mapping function fC(C) or fΔt(Δt). FIG. 4 outlines some examples of mapping functions f. Thus, for example, a small time requirement (e.g. max. 5 minutes) may not be incorporated into the total costs or the weighting coefficient 123, or a high cost requirement may be disproportionate. Start times occurring outside the preferred time interval 113 or an excessive time requirement may similarly result in a disproportionate increase in the weighting coefficient 123, e.g. “Take child to school at 10:00 hrs” or “2 hours' driving time from home to the supermarket”. The quantity x plotted on the x-axis may correspond to financial costs, a time requirement or the weighting coefficient. The values of the mapping functions are plotted on the y-axis. A first mapping function 410 corresponds to a linear relationship. A second mapping function 420 corresponds to a linear relationship with an offset, so that values below an x-value corresponding to the zero crossing of the mapping function 420 are ignored. A third mapping function 430 corresponds to a non-linear relationship which is shown here by way of example as a parabola. An increase in the value x can be more heavily incorporated into the weighting function and thus “penalized” if necessary.

The cost function S(ts) can then be evaluated depending on the possible start time is in the permissible time interval and, for example, the minimum value can be selected as the optimum value, or a value lying within the tolerance range around the minimum. For a sequence of activities, the sum of the (where relevant minimum) total costs of the individual activities can be calculated as the total costs SA:

$${S}_{A} = {\sum }_{i = 1}^{N} ( S ( {t}_{s} ( {A}_{i} ) ) + {\sum }_{j = 1}^{M} ( S ( {t}_{s} ( {O}_{j} ) )$$

It may be possible, e.g., for journey activities, to avoid consecutive journeys being separated by pauses. A reduction or even minimization of the total costs can be achieved by varying the sequence of tasks and by optionally only permitting sequences that are allowed in consideration of firm appointments or preferred time intervals. The total costs can be calculated for each of these configurations, and the configuration with the minimum costs SA can be selected. Since the number of variations may in principle be very high, their number can be reduced through heuristics. It could thus, for example, be defined as an additional criterion that as many journeys as possible are adjacent in time to fragment the use of time periods as little as possible. In the case of journeys, the end point of one route may, as previously mentioned, be the starting point of the next route. The number of permutations can also be restricted as a result. Similarly, firm appointments or locations can serve as an “anchor point” without variability. A cost and performance duration estimate can be carried out for an activity within a limited time period, since the costs and the time requirement may change dynamically e.g. with the traffic situation.

An exhaustive search can be carried out to determine the optimum in the case of a restricted number of configurations as described. If the requirements are too great for this, stochastic methods can be used for improvement in some disclosed embodiments. Thus, for example, an overall optimization of the parameters can be carried out using evolutionary algorithms, wherein the total costs are at least close to the overall minimum (e.g. at most 10% above it).

As already previously mentioned, the mobility agent may be software, the functionality of which runs on the device 100 (cf. FIG. 1). The device may correspond to a server (Volkswagen Cloud). An operator of the server on which the mobility agent runs is referred to below as an “internal service provider”, and any other operator of a further server (e.g. for traffic, weather or local public transport services) is referred to as an “external service provider”. A mobility planning for registered users can be carried out automatically in the background, wherein the user is kept up-to-date.

The user can define mobility time windows in his calendar, along with constraints such as e.g. route planning with the fastest route, minimum costs or environmental optimization. The destinations can be transferred directly from the calendar once released, so that a planning in which no further inputs may be required is possible for this purpose. The user can furthermore indicate mobility tasks (e.g. purchases) which are not definitely completed and which can be deferred by the mobility agent to improve or even optimize the planning. The user can define further preferences which are individually modifiable: selection of the possible means of transport, amount of walking in the case of multimode transport routes, interaction with agents of other persons (e.g. for a family vote or for a carpool to the workplace).

Along with user requirements of this type which the software extracts automatically from the calendar and task list in at least one disclosed embodiment, the mobility agent on the server may have the facility to use databases on the Internet which are user-independent. Databases may comprise map data for route planning, current traffic and weather information, timetables of local and long-distance public transport, toll and parking charges, currently free parking space or opening times of shops. Since this information may be equally relevant to a plurality of persons, it may be desirable to store the data in a server infrastructure on the Internet.

The mobility agent on the server may be designed to access personal and general information, e.g. on the Internet (Cloud). The mobility agent may furthermore propose a journey plan to the user, and the user can optionally accept this proposal. The corresponding travel times and destinations can thus be entered on the calendar and can be communicated to the user in different ways (e.g. personal website with travel details, notification via email and in social networks, push messages, etc.). If accepted by the user, the navigation destinations can be transferred by the software, for example, by means of a data transmission interface comprised by the device, into an on-board device of a vehicle to be used on the journey, and can be activated at a specified time. Navigation destinations can optionally be communicated to other users also. If external service providers are involved (e.g. car hire company, local/long-distance public transport), the mobility agent may be designed to carry out a transaction, for example, a reservation or booking, by accessing an external server of the external service provider.

Mobility requirements of the user can be simulated by some disclosed embodiments. Here, the mobility agent can be active at any times, or can also take account of constraints that change over time (e.g. toll charges or tailbacks depending on the time of day), and can adapt the planning accordingly. The mobility agent can merge different functions such as route planning and organization of a personal calendar. As a result, it may be possible to carry out an overall improvement or optimization (e.g. of total costs). The mobility agent can communicate with external service providers, but also with other mobility agents of other users, for example, to organize a carpool dynamically. The mobility agent can provide the other mobility agent, for example, with information on journey times, participants or possibly other intermediate stops. Conversely, conventional solutions may in many cases be “isolated solutions” which take no account or only insufficient account of a daily routine of the user from the perspective of the user. Through a release of times or relevant entries in the calendar, different activities (transport, purchases, tasks, meetings with third parties, etc.) can be clearly organized along the time axis and can be presented in a manner comprehensible to the user.

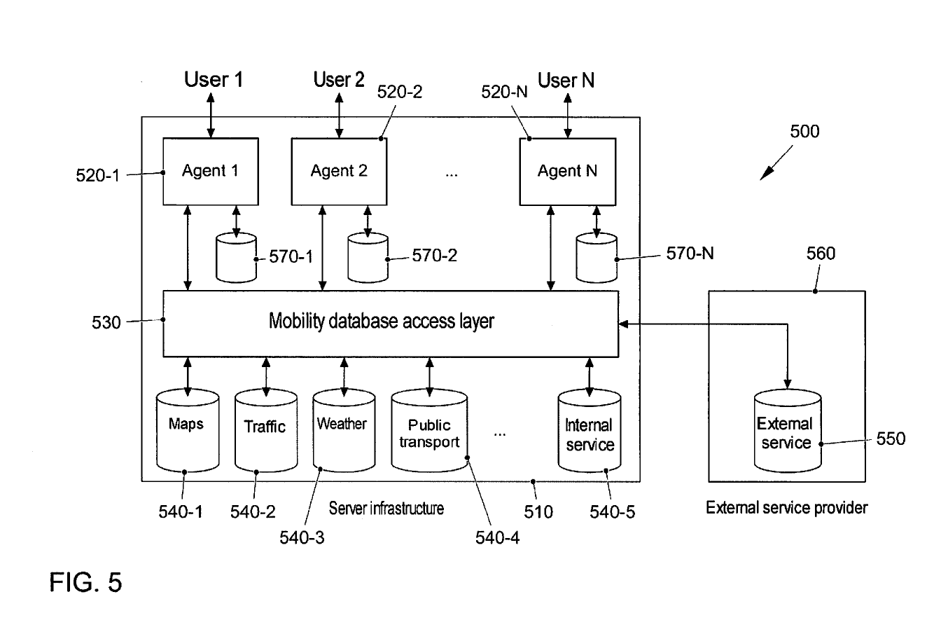

A possible architecture of the mobility agent is shown in FIG. 5. Any user n from a set of N users (N is any natural number here) of a system 500 is represented by a respective mobility agent n in a server infrastructure 510. A software module 520-1; 520-2; . . . ; 520-N is assigned to a mobility agent n, the module being designed to access mobility databases 540-1; 540-2; 540-3; 540-4; 540-5 and a service 550 of an external provider 560 via an access layer 530 (Mobility Services Access Layer). The external provider may be different from an operator of the system 500 which comprises the server infrastructure 510. The mobility databases 540-1; 540-2; 540-3; 540-4; 540-5 may comprise an internal service 540-5 which is made available e.g. by an operator of the server on which the mobility agent runs.

In the disclosed embodiment shown here, the mobility agent requests the information from the databases 540-1; 540-2; 540-3; 540-4; 540-5 via the access layer 530 for planning purposes. A private storage device 570-1; 570-2; . . . ; 570-N which can be populated with data of the respective user n and which is not accessible to other users is assigned in each case to a mobility agent n. For example, access to a private storage device 570-n may require an input of a password defined by the user n. However, one agent may establish contact with other agents via the access layer 530 to provide information relating to a service (e.g. spare places for a carpool) or to receive information relating to a service from a different agent (e.g. carpooling opportunities).

An agent may be authorized by the user to carry out transactions (e.g. a travel booking). To do this, it may also be designed to issue amounts or receive amounts if the agent provides a service for others (for example, offering spare places for a carpool).

The agent can represent a person as a user, but also an institution. Thus, for example, a local authority could be interested in feedback on the condition of roads, and could offer free parking in return. If a vehicle then detects a pothole by means of its sensor system, the agent of the vehicle user can exchange this information with the agent of the local authority.

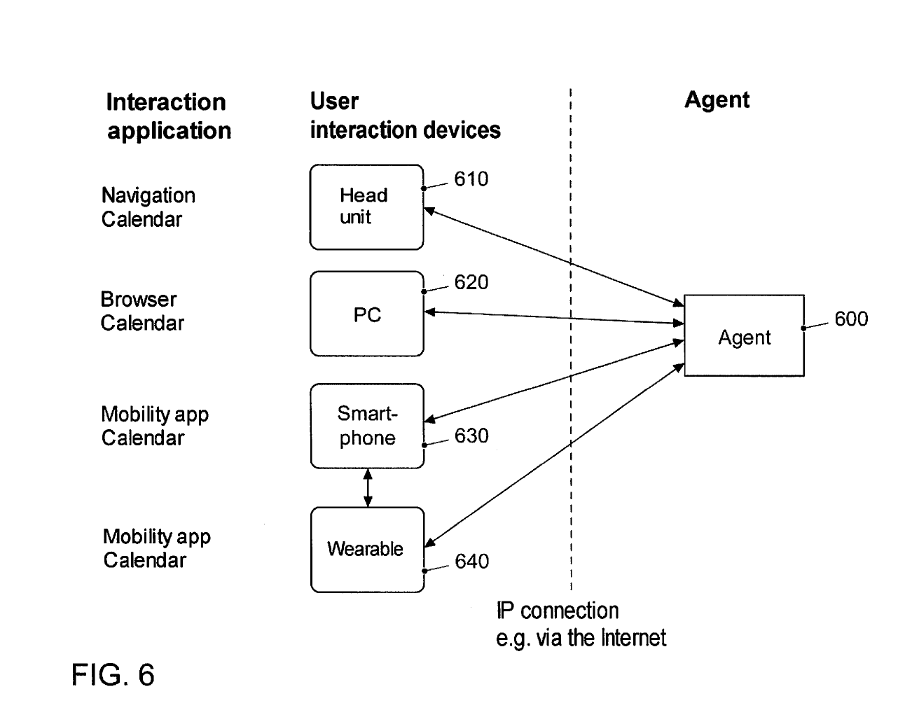

An interaction between a software module 600 of the mobility agent and the user is shown in FIG. 6 and can take place via different channels. In a vehicle, for example, the interaction can take place via a head unit 610, thereby improving the interaction in terms of ergonomics. Mobility requests can be submitted via spoken or written input. Alternatively, the interaction with the agent can take place on a personal computer (PC) 620 or with a mobile device, e.g. a smartphone 630. The mobility planning can be presented on these devices or on a wearable 640, e.g. a smartwatch. The interaction with the software model 600 of the mobility agent on the server may be an Internet protocol (IP) connection, and can take place e.g. by means of the Internet. If a head unit 610 is used, an interaction application may have a navigation or calendar, or may be comprised by programs which have a navigation or calendar. If a PC 620 is used, an interaction application may be a browser and may have a calendar. If a smartphone 630 or wearable 640 is used, an interaction application may be a mobility app and may have a calendar.

As an alternative to a server, a software module of the mobility agent can be implemented on a mobile or stationary terminal device. The software module could run e.g. on a central computer of a vehicle, on a PC or a mobile device such as a smartphone or tablet and could request data from a further, external device. In at least one disclosed embodiment of this type in which the mobility agent is implemented on a server, an improved use of processing power or a simplified reconciliation of (even conflicting) requirements of individual users may be possible in some instances.

A server-based solution may have better scalability in terms of a number of agents communicating with one another. Many data elements may be identical for the agents, e.g. maps or weather, so that a central storage is, wherever possible, more efficient. Similarly, a server solution may offer greater resilience since redundant operation may be possible in some instances. The user can use a continuous or at least regular connection to the software module of the mobility agent on the server to keep up-to-date with the planning, but, with local performance of a navigation, may also continue to navigate at least partially autonomously.

Conventional solutions may partition a daily planning task into separate areas, e.g. navigation, task list, arranging meetings with friends, etc. The present concept of the mobility agent according to some disclosed embodiments can undo this separation of tasks and merge them from a mobility planning perspective. An overall planning can thus be enabled for the user which may, where relevant, be free from conflicts, can enable improved trackability in a calendar of the user, or can be dynamically adapted.

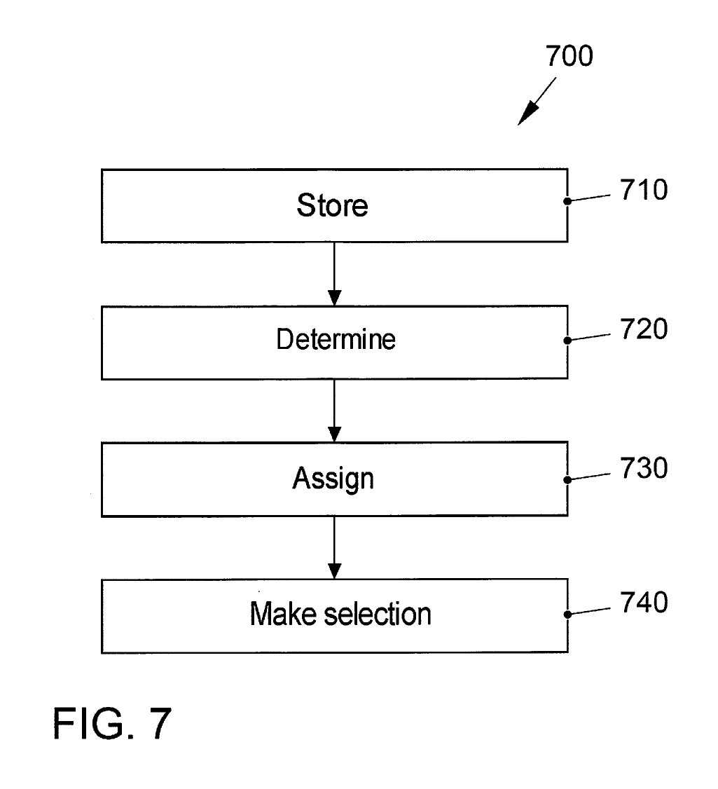

FIG. 7 shows a flow diagram of a method 700 for creating a temporal sequence of activities of a user according to at least one disclosed embodiment. The method 700 comprises a storage 710 of at least information relating to a planned activity of the user. The information relating to the activity comprises at least one time period available to the user to carry out the activity. The method 700 furthermore comprises a determination 720 of at least one combination of a possible beginning and a possible time duration of the activity within the time period available to the user. The method 700 furthermore comprises an assignment 730 of a weighting coefficient to the at least one combination. The method 700 furthermore comprises a making 740 of a selection from the at least one combination of a possible beginning and a possible time duration of the activity in such a way that a weighting term comprising the weighting coefficient assigned to the selected combination does not exceed a predefined limit value, and the selection from a beginning and a time duration of the activity does not overlap with an additional time duration of an additional activity stored in the storage module. A planning of activities can thus be produced in which conflicts in a temporal sequence can possibly be avoided. Furthermore, a temporal flexibility in the planning may be improved in some cases, or a planning facility can be created which allows an adaptation of the planning in line with temporally variable constraints.

Disclosed embodiments may be usable in connection with a vehicle. The mobility planning by means of a mobility agent according to disclosed embodiments may also extend beyond a means of transport. A multimode planning with further means of transport can be implemented and evaluated by means of disclosed embodiments. The concept of mobility agent software which acts for a user may be extendable to other areas beyond mobility. Another field of application may comprise e.g. an improvement or optimization of resource utilization (reduction or minimization of environmental pollution) in which users automatically offer resources (e.g. CO2 quota) and other parties can purchase these resources (e.g. factory operators).

The embodiments disclosed in the above description, the following claims and the attached figures can be relevant and can be implemented in their different configurations both individually and in any given combination for the implementation of at least one disclosed embodiment.

Although some disclosed embodiments are described in connection with a device, these embodiments also represent a description of the corresponding method, so that a block or a component of a device should also be understood as a corresponding method step or as a feature of a method step. Similarly, aspects that have been described in connection with or as a method step also represent a description of a corresponding block or detail or feature of a corresponding device.

Depending on specific implementation requirements, disclosed embodiments can be implemented in hardware or in software. The implementation can be carried out using a digital storage medium, for example, a floppy disk, a DVD, a Blu-ray disc, a CD, a ROM, a PROM, an EPROM, an EEPROM or a FLASH memory, a hard disk or a different magnetic or optical storage device on which electronically readable control signals are stored which can interact with a programmable hardware component or interact in such a way that the respective method is carried out.

A programmable hardware component may be formed by a processor, a computer processor (CPU=Central Processing Unit), a graphics processor (GPU=Graphics Processing Unit), a computer, a computer system, an application-specific integrated circuit (ASIC), an integrated circuit (IC), a system on chip (SoC), a programmable logic element or a field programmable gate array (FPGA) with a microprocessor.

The digital storage medium can therefore be machine-readable or computer readable. Some disclosed embodiments therefore comprise a data medium which has electronically readable control signals which are capable of interworking with a programmable computer system or a programmable hardware component in such a way that one of the methods described herein is carried out. At least one disclosed embodiment is therefore a data medium (or digital storage medium or a computer-readable medium) on which the program to carry out one of the methods described herein is recorded.

Generally speaking, disclosed embodiments can be implemented as a program, firmware, computer program or computer program product with a program code or as data, wherein the program code or the data is/are effective in carrying out one of the methods when the program runs on a processor or on a programmable hardware component. The program code or the data may, for example, also be stored on a machine-readable medium or data medium. The program code or the data may be provided, inter alia, as source code, machine code or byte code, or as a different intermediate code.

A further disclosed embodiment is a data stream, a signal sequence or a succession of signals which represent(s) the program to carry out one of the methods described herein. The data stream, the signal sequence or the succession of signals may, for example, be configured in such a way as to be transferred via a data communication connection, for example, via the Internet or via a different network. Disclosed embodiments are also signal sequences representing data which are suitable for transmission via a network or via a data communication connection, wherein the data represent the program.

A program according to at least one disclosed embodiment can carry out one of the methods during its execution, for example, by reading from storage locations or by writing a datum or a plurality of data to the storage locations, as a result of which switching processes or other processes in transistor structures, in amplifier structures or in other electrical, optical, magnetic components or components operating according to a different functional principle are, if necessary, invoked. Data, values, sensor values or other information can be acquired, determined or measured accordingly by a program by reading from a storage location. A program can therefore acquire, determine or measure variables, values, measurement variables and other information by reading from one or more storage locations, and can effect, instigate or perform an action and control other devices, machines and components by writing to one or more storage locations.

The disclosed embodiments described hereinabove merely represent an illustration of the principles of the embodiments. Modifications and variations of the arrangements and details described herein will obviously be evident to other experts. Disclosed embodiments are limited only by the scope of protection of the patent claims below, and not by the specific details that have been presented by way of the description and the explanation of the disclosed embodiments herein.

### REFERENCE NUMBER LIST

100 Device
110 Storage module
111 Information relating to the activity
112 Time period
113 Preferred time interval
114 Location information
120 Assignment module
121 Possible beginning of the activity
122 Possible time duration of the activity
123 Weighting coefficient
124 Further possible beginning of the activity
125 Further possible time duration of the activity
126 Further weighting coefficient
130 Calculation module
131 Weighting term
132 Limit value
133 Time duration of an additional activity
410 First mapping function
420 Second mapping function
430 Third mapping function
500 System
510 Server infrastructure
520-1; 520-2; 520-N Software module
530 Access layer
540-1; 540-2; 540-3; 540-4; 540-5 Databases
550 Service
560 External service provider
570-1; 570-2; 570-N Private storage device
600 Software module
610 Head unit
620 PC
630 Smartphone
640 Wearable
700 Method
710 Storage
720 Determination
730 Assignment
740 Making a selection

1. A device for creating a temporal sequence of activities of a user, the device comprising:
a storage module to store at least information on a planned activity of the user, wherein the information relating to the activity comprises at least one time period available to the user to carry out the activity;
an assignment module to determine at least one combination of a possible beginning and a possible time duration of the activity within the time period available to the user, and to assign a weighting coefficient to the at least one combination; and
a calculation module to make a selection from the at least one combination of a possible beginning and a possible time duration of the activity so a weighting term comprising the weighting coefficient assigned to the selected combination does not exceed a predefined limit value, and the selection from a beginning and a time duration of the activity does not overlap with an additional time duration of an additional activity stored in the storage module.

2. The device of claim 1, wherein the assignment module specifies the possible time duration depending on the possible beginning of the activity, and/or vice versa.

3. The device of claim 1, wherein the storage module stores the information relating to the activity, wherein the information comprises predefined location information for a location of the activity.

4. The device of claim 3, wherein the assignment module specifies the time duration on the basis of the location information.

5. The device of claim 3, wherein the assignment module assigns the weighting coefficient to the at least one combination on the basis of a distance between a position corresponding to the location information and a starting position of the user.

6. The device of claim 3, wherein the assignment module assigns the weighting coefficient to the at least one combination, wherein the starting position corresponds to additional location information assigned to the additional activity.

7. The device of claim 3, wherein the calculation module transmits a request signal on the basis of the location information to a further storage module which instigates a provision of a coordinate indication corresponding to the location information.

8. The device of claim 1, wherein the calculation module:
compares the combination of a possible beginning and a possible time duration of the activity with a further combination of a further possible beginning and a further possible time duration of the activity within the time period;
determines a local or overall minimum of the weighting term on the basis of the comparison; and
provides the user with the possible beginning and the possible time duration of the activity and/or an additional possible beginning and the additional possible time duration of the additional activity which correspond to the minimum of the weighting term within a predefined tolerance range.

9. The device of claim 1, wherein the storage module stores the information relating to the activity, wherein the information comprises a preferred time interval for the possible beginning and the possible time duration of the activity within the time period.

10. The device of claim 9, wherein the assignment module determines the weighting coefficient on the basis of a temporal position of the possible beginning of the activity in relation to the preferred time interval.

11. The device of claim 9, wherein the assignment module assigns the time duration or the possible beginning of the activity to the weighting coefficient via a non-linear relationship.

12. The device of claim 9, wherein the assignment module sets the weighting coefficient to a specified value above the predefined limit value if the possible beginning of the activity lies outside the preferred time interval.

13. The device of claim 1, wherein the assignment module assigns an additional weighting coefficient to the additional activity, and wherein the calculation module calculates the weighting term as the sum of the weighting coefficient and the additional weighting coefficient.

14. A method for creating a temporal sequence of activities of a user, the method comprising:
storing at least information relating to a planned activity of the user, wherein the information relating to the activity comprises at least one time period available to the user to carry out the activity;
determining at least one combination of a possible beginning and a possible time duration of the activity within the time period available to the user;
assigning a weighting coefficient to the at least one combination; and
making a selection from the at least one combination of a possible beginning and a possible time duration of the activity so a weighting term comprising the weighting coefficient assigned to the selected combination does not exceed a predefined limit value, and the selection from a beginning and a time duration of the activity does not overlap with an additional time duration of an additional activity stored in the storage module.

15. A program with a program code to carry out a method when the program code is executed on a computer, a processor or a programmable hardware component, the method comprising:
storing at least information relating to a planned activity of the user, wherein the information relating to the activity comprises at least one time period available to the user to carry out the activity;
determining at least one combination of a possible beginning and a possible time duration of the activity within the time period available to the user;
assigning a weighting coefficient to the at least one combination; and
a selection from the at least one combination of a possible beginning and a possible time duration of the activity so a weighting term comprising the weighting coefficient assigned to the selected combination does not exceed a predefined limit value, and the selection from a beginning and a time duration of the activity does not overlap with an additional time duration of an additional activity stored in the storage module.
